(19) United States
(12) Patent Application Publication
(10) Pub. No.: US 2024/0279043 A1
(43) Pub. Date: Aug. 22, 2024

(54) APPARATUS FOR SUPPLYING TREATED FLUID AND SANITARY FITTING

(71) Applicant: BLANCO GMBH + CO KG, Oberderdingen (DE)

(72) Inventors: Thomas ZÖLLNER, Wuppertal (DE); Kay SCHMIDT, Flehingen (DE)

(73) Assignee: BLANCO GMBH + CO KG, Oberderdingen (DE)

(21) Appl. No.: 18/443,766

(22) Filed: Feb. 16, 2024

(30) Foreign Application Priority Data
Feb. 17, 2023 (DE) 10 2023 201 390.8

(51) Int. Cl. B67D 1/00; B67D 7/76

(52) U.S. Cl. CPC B67D 1/0063; B67D 1/0076; B67D 1/0081; B67D 7/76; B67D 2210/0001; B67D 2210/00104

(57) ABSTRACT

The invention relates to a device for providing a treated fluid, in particular of drinking water, comprising a treatment device with at least one treatment container for treating the fluid and a temperature control device for controlling the temperature of the fluid in the at least one treatment container, preferably for cooling it, wherein at least one pre-temperature control device is provided with at least one container for the temperature control of the untreated fluid, wherein the container has an inlet for non-temperature-controlled, untreated fluid and an outlet where temperature-controlled, untreated fluid can be supplied, and that the temperature control device is designed such that
a) the temperature-controlled, untreated fluid in the direction of flow prior to treatment by the treatment device can be temperature-controlled by the temperature control device for the treatment device, or
b) the untreated fluid can be temperature-controlled by the temperature control device before and/or during treatment in the treatment device and/or when the treated fluid is withdrawn from the treatment device.

The invention relates to a device for supplying a treated fluid, in particular drinking water, comprising a treatment device with at least one treatment container for treating the fluid and a temperature control device for controlling the temperature of the fluid in the at least one treatment container, preferably for cooling the fluid.

The invention also relates to a sanitary valve system for dispensing temperature-controlled and/or treated fluid, in particular drinking water, comprising a device for supplying treated fluid and at least one outlet for dispensing the temperature-controlled and/or treated fluid, wherein the at least one outlet is connected to the device.

Although this invention is generally applicable to any treatment device, this invention will be described in relation to treatment devices in the form of carbonators for drinking water.

Treatment devices for enriching beverages with carbon dioxide are available in many different forms in the prior art. These treatment devices include, for example, integrated carbonator containers with a volume of approx. 1-2 litres for beverage cooling and, if necessary, pre-cooling pipes for storing chilled still water and sparkling water for the beverage dispensing taps. An uncooled and non-insulated water filter, such as an activated carbon filter or ion exchanger, may be installed upstream of these cooling units. When water is drawn from the tap, it first flows from this filter into the carbonator's cooling area. During longer periods of non-use, the water in the filter warms up to ambient temperature. This may rise to over 40° C., particularly if the treatment device is installed in a kitchen base unit. This water is rapidly mixed with the already cooled water in the standard cooling devices with a carbonator and/or cooling pipe, so that a significantly higher dispensing temperature is reached after only a few 100 ml of the beverage is dispensed. This also leads to less CO₂ being bound in the drink. Another disadvantage is that higher temperatures also increase the hygienic risk, especially in the filter, during extended downtime.

DE 199 33 118 A1 describes a water treatment system for drinking water with a dispensing device, in which both still water and carbonated water can be supplied from two containers connected in series. There is also a cooling device for the water containers with greater cooling of the second container. The drinking water can be cooled through cooling coils of a refrigeration unit surrounding the containers, with additional lengths of the cooling coils being used for the second container as required.

The drawback is that the water treatment system is inflexible and inefficient, as the water containers must be supplied with refrigerant separately. In addition, the cooled water warms up again in the pipes before it is fed to the carbonators. As a result, there is still a hygiene risk if no carbonated water is drawn for a longer period of time.

Therefore, one objective of this invention is to create a device for supplying treated fluid and a sanitary dispensing system which provides more effective temperature control and reduces the risk to hygiene while providing sufficient quantities of treated fluid.

Another objective of the present invention is to provide an alternative device for providing treated fluid and an alternative sanitary dispensing system.

In one embodiment, this invention may solve the above-mentioned objectives by a device for supplying a treated fluid, in particular beverages, comprising a treatment device with at least one treatment container for treating the fluid and a temperature control device for controlling the temperature of the fluid in the at least one treatment container, preferably for cooling it, in that at least one pre-temperature control device is provided with at least one container for controlling the temperature of the untreated fluid, the container having an inlet for non-temperature-controlled, untreated fluid and an outlet from which temperature-controlled, untreated fluid can be provided, and in that the temperature control device is designed such that
a) the temperature-controlled, untreated fluid in the direction of flow prior to treatment by the treatment device can be temperature-controlled by the temperature control device for the treatment device, or
b) the untreated fluid can be temperature-controlled by the temperature control device before and/or during treatment in the treatment device and/or when the treated fluid is withdrawn from the treatment device.

In an embodiment, this invention also may solve the aforementioned objectives with a sanitary tap for dispensing temperature-controlled and/or treated fluid, in particular drinking water, which comprises a device according to one of claims 1-16 and at least one outlet for dispensing the temperature-controlled and/or treated fluid, which is connected to the device.

One of the advantages of this is that efficient temperature control can be provided while efficiently treating the water simultaneously. Another advantage is that a sufficient supply of treated, and temperature-controlled fluid can be provided while at the same time reducing the hygiene risk.

The term “sanitary” is to be understood in the broadest sense and refers, in particular in the description, preferably in the claims, among others, to any objects, arrangements, devices, equipment and the like in connection with bathrooms, kitchens, heating systems and the like.

Further features, advantages and embodiments of the invention are described below or are disclosed therein.

A preferred embodiment of the invention is that the at least one pre-temperature control device and the temperature control device are integrated in a common temperature control circuit, in particular with the at least one pre-temperature control device positioned downstream of the temperature control device in the temperature control circuit. One potential advantage of this is that both temperature control devices can be supplied with temperature control medium easily and efficiently.

A further preferred embodiment of the invention is that the temperature control device and the at least one pre-temperature control device are arranged in series or parallel to each other in the temperature control circuit. The advantage of arranging it in series is that it allows for particularly efficient temperature control, whereas a parallel arrangement allows the temperature control devices to be controlled easily and flexibly, if necessary separately.

A further preferred embodiment of the invention is a switching device for feeding untreated, temperature-controlled fluid to an outlet and/or for feeding it to the treatment process, specifically by means of a three-way valve. The advantage of this is that it provides flexible control of the flow of the untreated, temperature-controlled fluid.

A further preferred embodiment of the invention is that a fluid transport device, in particular a pump, is arranged in the fluid transport path, preferably in the fluid transport path between the at least one pre-temperature control device and the temperature control device. This is a simple and efficient way of transporting fluid.

A further preferred embodiment of the invention is that a number of pre-temperature control device devices are arranged in parallel or in series with one another with reference to the fluid transport path. The advantage of this is that lower temperatures can be reached more quickly if temperature control in the form of cooling is used.

A further preferred embodiment of the invention is that fluid treated using a switching arrangement, fluid temperature-controlled using several temperature control devices or a mixture of these can be fed to an output, specifically using at least two valves. This facilitates the flexible dispensing of different types of fluid.

A further preferred embodiment of the invention is that the at least one pre-temperature control device comprises a second treatment device, in particular a filtration device with at least one filter, which can be temperature-controlled by the pre-temperature control device. The advantage of this is the increased flexibility in the provision of different treated fluids.

A further preferred embodiment of the invention is that the at least one pre-temperature control device and/or the temperature control device has pipes for the temperature control circuit which are arranged in the area of the wall of the container and/or the treatment container, in particular where these are located in an insulating material and/or in an air-filled volume, preferably on the radial outer side of the container and/or treatment container. The advantage of this is efficient temperature control of the respective container contents.

A further preferred embodiment of the invention is that the supply pipe to the treatment device is positioned at least in part inside a wall of the treatment container, in particular in an insulating material. The advantage of this is further pre-temperature control of the fluid to be treated by the temperature control device of the treatment device, which allows for particularly reliable temperature control.

A further preferred embodiment of the invention is that the treatment container is positioned at least partially in the container of the at least one pre-temperature control device. The advantage of this is efficient utilisation of the available space.

A further preferred embodiment of the invention is that the treatment container and the container of the pre-temperature control device are located in a shared housing. This facilitates efficient insulation overall and short cable lengths, for example.

A further preferred embodiment of the invention is that a recirculation circuit is configured so that temperature-controlled, untreated fluid is returned to the pre-temperature control device via the temperature control device for the temperature control of untreated, non-temperature-controlled fluid. In this way, the pre-temperature control device can also be temperature-controlled without being directly connected to a temperature control circuit.

A further preferred embodiment of the invention is that the recirculation circuit can be activated using a recirculation switching device. The advantage of this is that the agitation circuit can be efficiently activated as required.

A further preferred embodiment of the invention is that the at least one pre-temperature control device and/or the temperature control device include a phase change reservoir and/or a salt water low temperature reservoir with at least one heat exchanger. The advantage of this is the increased flexibility to add an appropriate reservoir depending on the installation space, availability and desired temperature control.

A further preferred embodiment of the invention is that the treatment device is designed as a carbonator for carbonating drinking water, including in particular a refillable CO₂ reservoir. This allows for the efficient supply of CO₂-enriched fluid.

Other important features and advantages of the invention result from the dependent claims, from the drawings and the corresponding description of the figures using the drawings.

It is understood that the above-mentioned features, and features yet to be explained below, may be used not only in the respectively indicated combination, but rather also in other combinations or alone, without departing from the scope of the present invention.

Preferred designs and embodiments of this invention are shown in the accompanying drawings and are explained in more detail in the following description, wherein identical reference numbers refer to identical or similar or functionally identical components or elements.

In the form of a diagram,

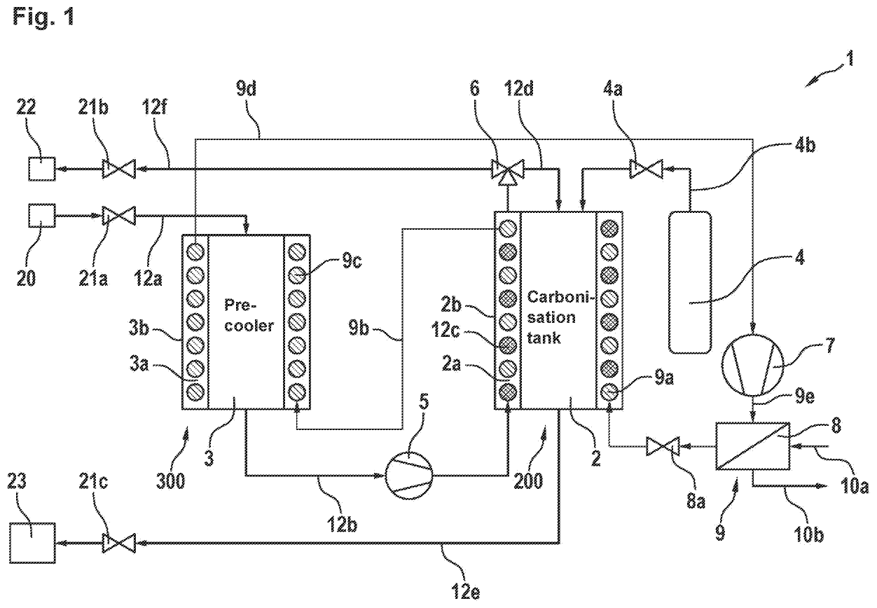

FIG. 1 shows a carbonization device according to one embodiment of this invention;

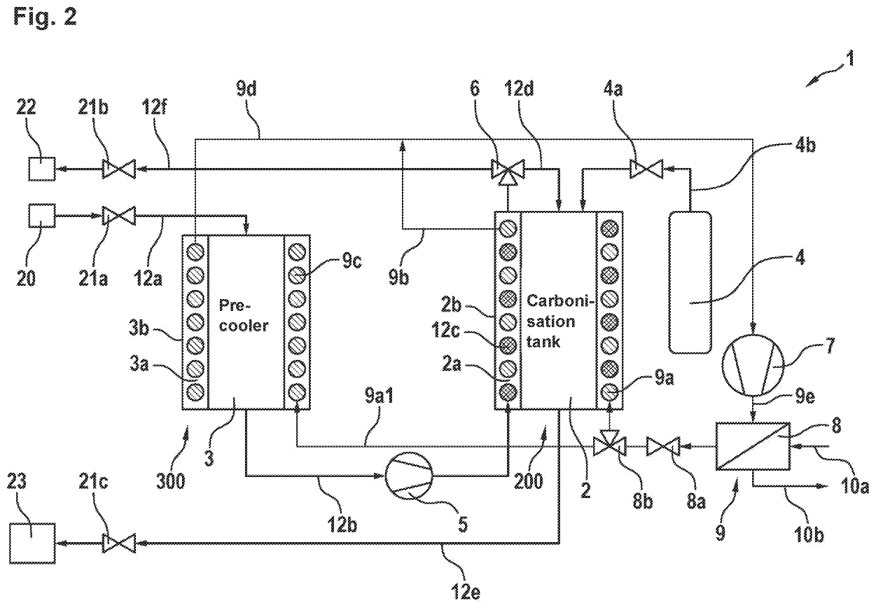

FIG. 2 shows a carbonization device according to one embodiment of this invention;

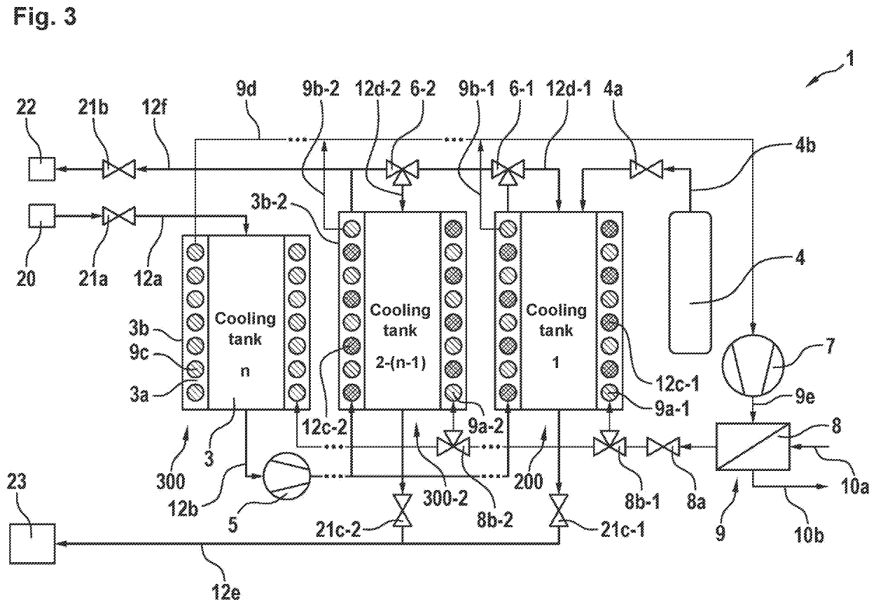

FIG. 3 shows a carbonization device according to one embodiment of this invention;

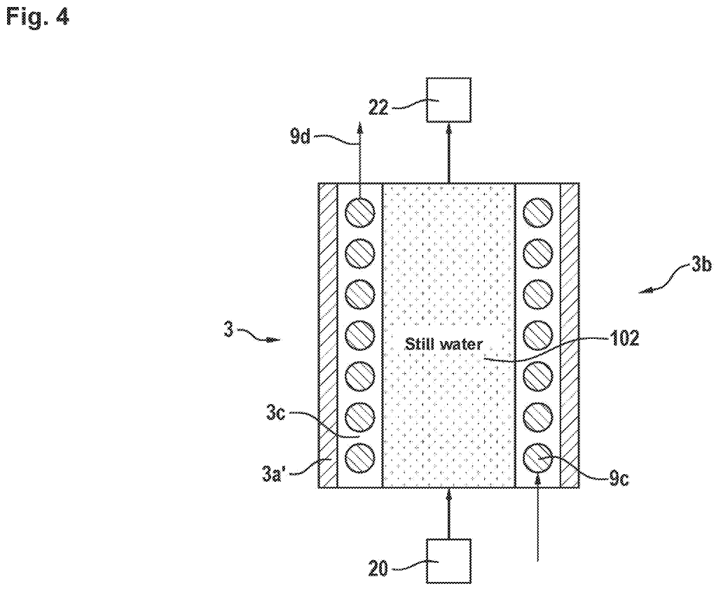

FIG. 4-7 show various pre-temperature control and temperature control devices according to embodiments of this invention; and

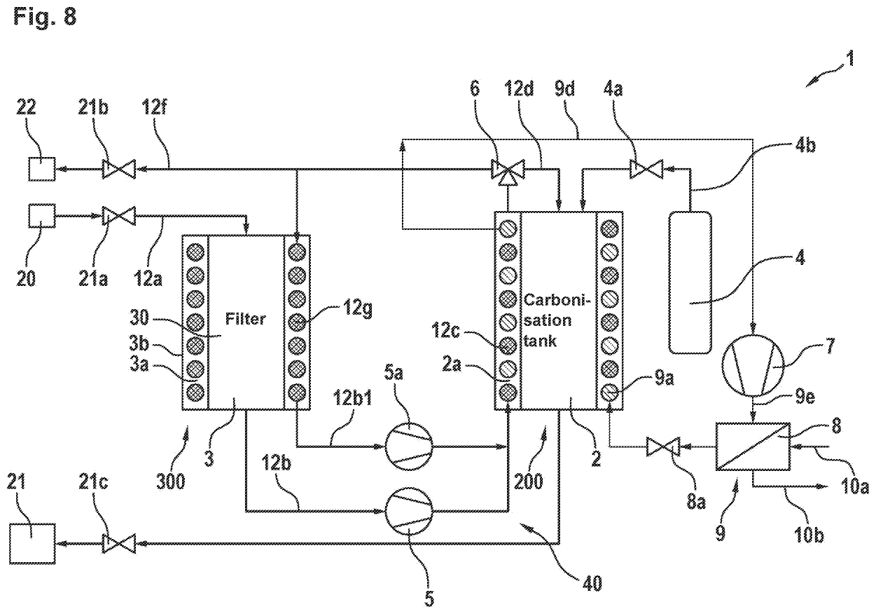

FIG. 8 shows a carbonization device according to one embodiment of this invention.

FIG. 1 shows a carbonization device according to one embodiment of this invention.

In FIG. 1, carbonation device 1 for a beverage, in particular drinking water, is shown. This comprises carbonator 200 with container 2 and pre-cooling device 300 with container 3. The respective containers 2, 3 have either a sleeve or a wall 2b, 3b fitted onto the container, in which insulation 2a, 3a is installed. One or more pipes 9c of a cooling circuit 9 are arranged helically in wall 3b of pre-cooling device 300. Also located in wall 2b of container 2 are pipes 9a of cooling circuit 9 and pipes 12c for dispensing drinks or drinking water.

Cooling circuit 9 comprises condenser 8, which is connected to pipes 10a, 10b of an unspecified condensing cooling circuit. Starting from condenser 8, an expansion device is arranged downstream either in the form of a capillary or—as in this case—expansion valve 8a, which is then connected to the aforementioned pipe 9a in wall 2b of container 2. On the side opposite container 2 vertically—at the top in FIG. 1—pipe 9a is connected via pipe 9b to pipe 9c in wall 3b of container 3, the inlet of which is located at the bottom of container 3 in FIG. 1. On the side opposite container 3 vertically—at the top in FIG. 1—pipe 9c is connected via pipe 9d to compressor 7, which in turn is connected to the described condenser 8 via pipe 9e.

The following describes dispensing beverages in the form of drinking water but is not limited to this. Starting from drinking water supply device 20, drinking water is fed into container 3 of pre-cooling device 300 via controllable valve 21a and pipe 12a. The drinking water is pre-cooled using pipe 9c of cooling circuit 9, which is located in wall 3b. After cooling in pre-cooling device 300, the pre-cooled drinking water is transported by means of pipe 12b and pump 5 into pipe 12c, which also passes through wall 2b of container 2 along with the helically arranged pipe 9a of cooling circuit 9, notably in an alternating pattern.

This allows the pre-cooled drinking water to be cooled again by cooling circuit 9 before being fed into container 2. Pipe 12c is then connected to three-way valve 6, which allows for fluid connection to container 2 via pipe 12d as well as output 22 of the cooled drinking water via pipe 12f and a switchable valve 21b.

As described above, pipe 12d flows into container 2. In addition, CO₂provided by CO₂ reservoir 4 can be fed into container 2 via pipe 4b and switchable valve 4a to facilitate enrichment of the pre-cooled drinking water with CO₂. The drinking water enriched with CO₂ can be dispensed via pipe 12e and switchable valve 21c at outlet 23, for example an outlet of a sanitary valve or similar.

FIG. 2 shows a carbonization device according to one embodiment of this invention.

FIG. 2 essentially illustrates carbonization device 1 as shown in FIG. 1. In contrast to carbonization device 1 as shown in FIG. 1, carbonization device 1 as shown in FIG. 2 has three-way valve 8b in cooling circuit 9 downstream of expansion valve 8a, which provides a fluid connection to pipes 9a in wall 2b of container 2 on the one hand and to pipe 9c in the wall of container 3 via pipe 9a1 on the other. Pipe 9b is connected to pipe 9d downstream after passing through wall 3b of container 3. Essentially, FIG. 2 shows cooling circuit 9 where the two containers 2, 3 are “connected in parallel” for cooling, whereas FIG. 1 shows the containers 2, 3 connected “in series” for cooling.

FIG. 3 shows a carbonization device according to one embodiment of this invention.

FIG. 3 essentially illustrates carbonization device 1 as shown in FIG. 2. In contrast to carbonization device 1 as shown in FIG. 2, several pre-cooling devices 300, 300-2 are arranged in carbonization device 1 as shown in FIG. 3. Pre-cooling device 300 is arranged in the direction of flow from the drinking water supply 20 and corresponds to pre-cooling device 300 as shown in FIG. 2. In contrast to this and similarly to the design of pipes 9a-1, 12c-1 for container 2, the additional pre-cooling device 300-2 features pipe 9a-2 of the cooling circuit 9 and a drinking water pipe 12c-2 in wall 3b-2.

In addition, downstream of pump 5, drinking water pipe 12c-2 of container 3-2 and drinking water pipe 12c-1 of container 2 can be supplied in parallel with pre-cooled drinking water from container 3.

Similarly to three-way valve 6-1, which is connected to pipe 12c-1 and which enables a fluid connection to container 3 via pipe 12d-1 as well as outlet 22 of the cooled drinking water via pipe 12f and switchable valve 21b, pipe 12c-2 also opens into pipe 12f and drinking water can be fed from pipe 12c-2 into container 3-2 via additional three-way valve 6-2 and pipe 12d-2. Water from containers 3, 3-2 can be selectively connected to water outlet 23 either individually or fluidically mixed via corresponding extraction pipes with switchable valves 21c-1, 21c-2.

Cooling circuit 9 as shown in FIG. 3 has essentially the same structure as cooling circuit 9 as shown in FIG. 2. Additional pre-cooling device 300-2 is integrated into cooling circuit 9 via an additional three-way valve 8b-2.

FIGS. 4-7 show various pre-temperature control and temperature control devices according to embodiments of this invention.

FIG. 4 essentially shows container 3 for a pre-cooling device for pre-cooling still water 102, which is then fed to water outlet 22 after pre-cooling in container 3 from water supply 20. Container 3 includes wall 3b, in which one or more pipes 9c of cooling circuit 9 are located. These can be placed in a metal block, made in particular from aluminum, or in a volume filled with air—reference 3c. Insulating material 3a′ can be fitted on the radial outer side of wall 3b.

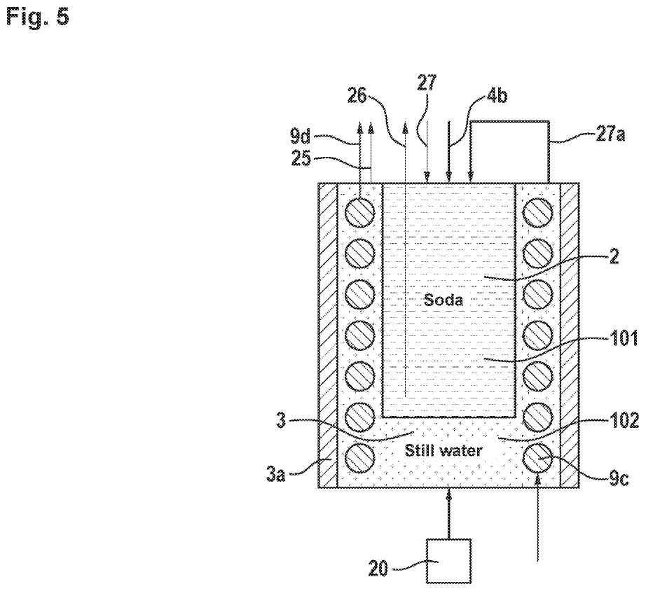

In FIG. 5, in contrast to FIG. 4, pipe 9c is run inside container 3 and can be supplied with still water 102 directly. Container 2 for soda 101 is located in container 3, which has insulation 3a on the radial outer side. This is therefore also indirectly cooled with pipe 9c of the cooling circuit via the surrounding still water 102. It is also possible to arrange pipe 9c such that it is located directly on the outside of container 2 for soda 101 in order to improve cooling. The water which is to be carbonated can be supplied to container 2 either via pipe 27a from container 3 or via separate supply pipe 27. Still water 102 can be removed from container 3 via pipe 25 and carbonated water can be removed from container 2 via pipe 26. As in the embodiments shown in FIGS. 1-3 above, container 3 is connected to CO₂supply pipe 4b to introduce CO₂.

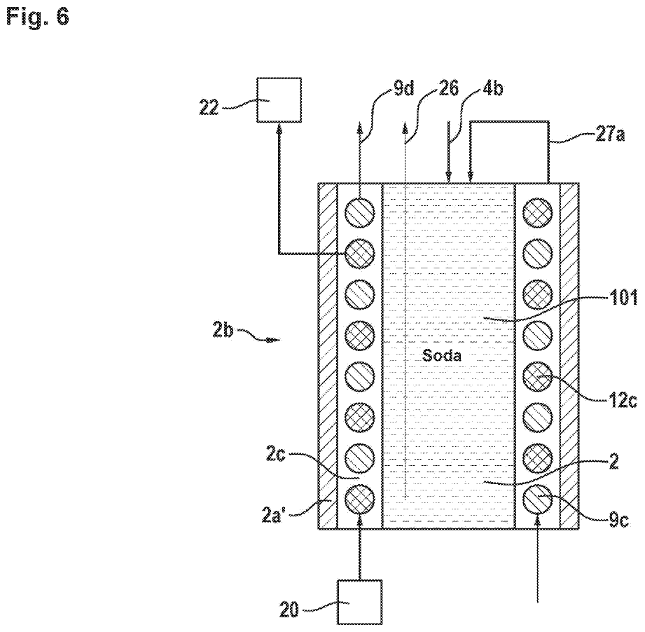

FIG. 6 illustrates container 2 for the carbonization of still water as shown in FIG. 1. As in FIG. 1, container 2 is cooled by pipe 9c of cooling circuit 9. Also shown here is insulation 2a′ arranged on the radial outer side. Water supply 20 of still water for enrichment with CO₂ is carried out here via pipe 12c located in air-filled volume 2c, which can be connected either directly to water outlet 22 for dispensing cooled still water or via pipe 27a to container 2 for CO₂ enrichment. Soda 101 can be drawn off directly using extraction pipe 26.

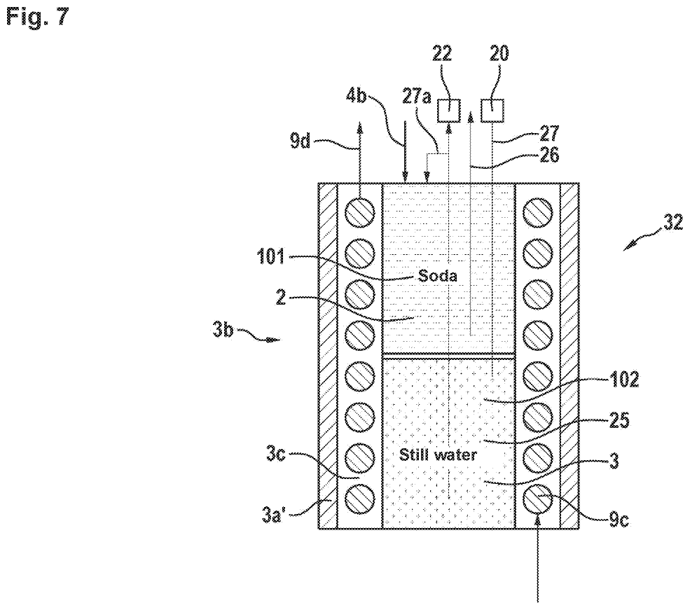

In contrast to the “container-in-container” embodiment of FIG. 5, FIG. 7 illustrates one overall container 32, which comprises the container 3 for still water 102 in the lower region and the container 2 for soda 101 in the upper region. Overall container 32's wall design corresponds to that of container 3 in FIG. 4 and includes only one or more pipes 9c of cooling circuit 9.

Water supply 20 for container 3 can be provided via supply pipe 27, which passes through container 2 into container 3. The same also applies to the corresponding extraction pipe 25 for still water 102 from container 3. This extraction pipe 25 can also supply cooled water from container 3 to container 2 for CO₂ enrichment via pipe 27a. As in the embodiments shown in FIGS. 1-3 above, container 3 is connected to CO₂ supply pipe 4b to introduce CO₂.

FIG. 8 shows a carbonization device according to one embodiment of this invention.

FIG. 8 essentially illustrates carbonization device 1 as shown in FIG. 1. In contrast to the carbonization device 1 as shown in FIG. 1, in carbonization device 1 as shown in FIG. 8, pre-cooling device 300 is equipped with an additional treatment component in the form of filter 30, which filters the fluid to be cooled in container 3. Another difference is that container 3 is no longer integrated into cooling circuit 9, meaning that pipes 9b, 9c are no longer required and pipe 9a is connected directly to pipe 9d.

Instead of pipe 9c, there is now a drinking water pipe 12g in insulation 3a, which can be used to cool container 3. Pipe 12g is connected via pipe 12b1 to a circulation pump 5a for this purpose, which in turn is connected to pipe 12b and pipe 12c for container 2. In addition, a fluidic connection with pipe 12g is positioned in pipe 12f between the three-way valve 6 and valve 21b. If circulation pump 5a is activated and a fluidic connection is established between pipe 12c and pipe 12f using three-way valve 6 and valve 21b is closed, container 3 can be cooled using the water that is additionally cooled by cooling circuit 9 prior to CO₂ enrichment. This forms recirculation circuit 40.

Overall, in all embodiments of FIGS. 1-8, with the exception of FIG. 5, the temperature control can be carried out using an external, in particular retrofittable, sleeve with the pipes shown around the housing of the respective container. Moreover, in all these embodiments, the temperature control pipes, i.e., in particular pipes 9a, 9a-1, 9a-2, 9c, 12c, 12c-1, 12c-2, 12g, can be arranged in a serpentine pattern, spiral or a similar form.

The temperature can be controlled using a control device, not shown here, which regulates the temperature as required or on a time schedule by controlling the corresponding valves, pumps in the water supply and the cooling circuit according to sensor information such as the temperature in the containers, the quantity and type of fluid to be dispensed or similar.

In summary, at least one of the embodiments of the invention may provide one of the following features and/or provide at least one of the following advantages:
Reduced hygiene risk.
Improved, in particular faster and more efficient, temperature control, especially cooling.
Higher delivery rate and faster supply of temperature-controlled fluid.
Reduced temperature control losses.

Although the present invention was described using preferred embodiments, it is not limited to these, but rather may be modified in various ways.

### LIST OF REFERENCE SIGNS

1 Carbonization unit
2 Containers
2a, 2b Insulation
3, 3-2 Containers
2a, 2a′, 3a, 3a′ Insulation
2b, 3b, 3b-2 Wall
2c, 3c Air-filled volume
4 CO₂ storage container
4a Pressure regulation valve
4b CO₂ supply pipe
5, 5a Pump
6 Three-way valve
7 Compressor
8 Condensing unit
8a Expansion valve
8b, 8b-2 Three-way valve
9 Cooling circuit
9a-e, 9a-1, 9a-2 Cooling circuit pipes
10a, 10b Condensing unit cooling water pipe
12a-f, 12b1, 12c-1 Water pipes
20 Water supply, drinking water supply
21a-c Valve
22 Output of unenriched water
23 Output of carbonated water
25 Still water drainage
26 Soda drainage
27, 27a Supply of still water
30 Filter element
32 Entire container
40 Recirculation circuit
101 Treated water
102 Still water
200 Carbonator
300, 300-2 Pre-cooling unit

1. A device for providing treated fluid, in particular drinking water, comprising a treatment device with at least one treatment container for treating the fluid and with a temperature control device for controlling the temperature of the fluid in the at least one treatment container, preferably for cooling it, characterized in that at least one pre-temperature control device is provided with at least one container for the temperature control of the untreated fluid, wherein the container has an inlet for non-temperature-controlled, untreated fluid and an outlet where temperature-controlled, untreated fluid can be supplied, and that the temperature control device is designed such that
a) the temperature-controlled, untreated fluid in the direction of flow prior to treatment by the treatment device can be temperature-controlled by the temperature control device for the treatment device, or
b) the untreated fluid can be temperature-controlled by the temperature control device before and/or during treatment in the treatment device and/or when the treated fluid is withdrawn from the treatment device.

2. The device according to claim 1, characterized in that the at least one pre-temperature control device and the temperature control device are integrated in a common temperature control circuit, in particular wherein the at least one pre-temperature control device (300) is arranged in the temperature control circuit downstream of the temperature control device.

3. The device according to claim 2, characterized in that the temperature control device and the at least one pre-temperature control device are arranged in series or parallel to one another in the temperature control circuit.

4. The device according to claim 1, characterized by a switching device which can be used to feed untreated, temperature-controlled fluid to an output and/or to supply it for treatment, in particular in the form of a three-way valve.

5. The device according to claim 1, characterized in that a transport device, in particular a pump, is arranged in the fluid transport path, preferably in the fluid transport path between the at least one pre-temperature control device and temperature control device.

6. The device according to claim 1, characterized in that a number of pre-temperature control devices are arranged in parallel or in series with one another with reference to the fluid transport path.

7. The device according to claim 6, characterized in that fluid treated using a switching arrangement, fluid temperature-controlled using several temperature control devices or a mixture of these can be fed to an output, specifically using at least two valves.

8. The device according to claim 1, characterized in that the at least one pre-temperature control device comprises a second treatment device, in particular a filtration device with at least one filter, which can be temperature-controlled by the pre-temperature control device.

9. The device according to claim 1, characterized in that the at least one pre-temperature control device and/or the temperature control device has pipes for the temperature control circuit which are arranged in the area of the wall of the container and/or the treatment container, in particular where these are located in an insulating material and/or in an air-filled volume, preferably on the radial outer side of the container and/or treatment container.

10. The device according to claim 1, characterized in that a supply pipe to the treatment device is arranged at least partly in a wall of the treatment container, in particular in an insulating material.

11. The device according to claim 1, characterized in that the treatment container is arranged at least partially in the container of the at least one pre-temperature control device.

12. The device according to claim 1, characterized in that the treatment container and the container of the pre-temperature control device are arranged in a common housing.

13. The device according to claim 1, characterized in that a recirculation circuit is configured so that temperature-controlled, untreated fluid is returned to the pre-temperature control device via the temperature control device for the temperature control of untreated, non-temperature-controlled fluid.

14. The device according to claim 13, in that the recirculation circuit can be switched on using a recirculation switching device.

15. The device according to claim 1, characterized in that the at least one pre-temperature control device and/or the temperature control device includes a phase change reservoir and/or a salt water low temperature reservoir with at least one heat exchanger.

16. The device according to claim 1, characterized in that the treatment device is designed as a carbonator for carbonating drinking water, including in particular a refillable CO2 reservoir.

17. A sanitary valve system for dispensing temperature-controlled and/or treated fluid, in particular drinking water, comprising a device according to claim 1 and at least one outlet for dispensing the temperature-controlled and/or treated fluid, which is connected to the device.
